(19) United States
(12) Patent Application Publication
(10) Pub. No.: US 2009/0172009 A1
(43) Pub. Date: Jul. 2, 2009

(54) Carpool or Ride Matching by wireless digital messaging Linked Database

(75) Inventors: Ronald Schmith, Salt Lake City, UT (US); Ted Stockett, Orem, UT (US)

Correspondence Address: Ronald Schmith, 2443 Blaine Ave, Salt Lake City, UT, 84108, US

(73) Assignee: Carpools Consolidated Corporation, Salt Lake City, UT (US)

(21) Appl. No.: 12/005,718

(22) Filed: Dec. 28, 2007

(51) Int. Cl. G06F 17/30; G06F 15/16; G06Q 99/00

(52) U.S. Cl. 707/102; 709/202; 705/1; 707/E17.032

(57) ABSTRACT

Systems, methods, and computer program products match a candidate passenger with a driver for a trip toward a common direction. A candidate passenger for the trip is automatically identified based on the physical start-address and direction sent to the database via text messaging (Short Message Service) or by wireless email. The driver is provided a means of contacting or locating the identified candidate passenger.

### CROSS-REFERENCE TO RELATED APPLICATIONS

### References Cited [Referenced By]

### U.S. Patent Documents

Note: This invention utilizes Short Message Service technology (SMS). According to www.imconf.net/imc-2006/papers/p26-zerfos.pdf SMS was conceived in 1992 therefore, all patent search references prior to 1992 have been deleted as “not related”
U.S. Pat. No. 6,675,150 January 2004 Camer et al. (based on Origin & destination)
U.S. Pat. No. 6,925,381 August 2005 Adamczyk et al. (based on GPS, & destination)
U.S. Pat. No. 6,584,401 June 2003 Kirshenbaum, et al. (based on GPS, & destination)
U.S. Pat. No. 6,925,381 August 2005 Adamczyk, et al (based on GPS & destination)
U.S. Pat. No. 7,047,888 May 2006 Richards, et al. (based on Origin & destination)
U.S. Pat. No. 7,062,376 June 2006 Oesterling, et al. (based on GPS, & recorded route)
U.S. Pat. No. 7,080,019 July 2006 Hurzeler, et al. (based on origin & destination)
U.S. Pat. No. 7,082,364 July 2006 Adamczyk, et al. (based on GPS, & destination)
U.S. Pat. No. 7,191,057 March 2007 Adamczyk, et al. (based on GPS, & destination)
App 20010056363 June 2001 Grantz et al. (based on email & destination)
App 20040049424 Mar. 2004 Murray et al. (based on GPS & destination)
App 20040267449 Dec. 2004 Adamczyk et al. (based on GPS & destination)
App 20050251333 Nov. 2005 Adamczyk et al. (based on GPS & destination)
App 20060200306 Sep. 2006 Adamczyk et al. (based on GPS & destination)
App 20060276960 Dec. 2006 Adamczyk et al. (based on GPS & destination)
App 20060293937 Dec. 2006 Solm et al. (based on website & schedule)
App 20070276595 Nov. 2007 Lewinson, et al (based on website & destination) None of the above listed patents and applications match ride partners by the combination of: start-location & travel-direction. We have found no other ride matching patent documents newer than 1992 at the USPTO search website.

### STATEMENT REGARDING FEDERAL SPONSORS

This invention was not sponsored by any federal sponsor.

This invention has been developed independently.

There is no joint research agreement.

### BACKGROUND OF THE INVENTION

The present invention is based generally on the field of data communications and relates to ride matching systems.

More particularly, this invention relates to a method and means to provide commuters throughout the United States with access to and use of a subscriber managed database and associated programming that operate in real time, allow direct and near-immediate communication between potential ride sharing partners, increase the safety of participants by ejecting violators, and provides a way to preserve the anonymity and privacy of users.

Until now, carpooling has been restricted to ride partners who schedule a ride to the same destination. This often restricts the freedom to vary the time and destination. This invention solves this problem by matching only: start location, and direction. Driver or passenger is free to part ways anywhere along the trip.

Since this method of ride sharing is more spontaneous and gives a greater level of freedom than the old “bulletin board” method, this invention also satisfies the resulting need to find immediate partners in the area on a real-time basis. A carpool is created within seconds of a candidate passenger's need. As soon as a driver's path deviates from the passenger's path, the passenger gets out and quickly finds a new driver.

Safety is also improved because a subscriber's cell phone number is registered to a database where the subscriber has to live up to the terms of service. One or more offenses result in the termination of a subscriber's membership. This creates a society of members where any subscriber will feel more secure in riding with another member.

Communication through the system is made possible without the need to give out phone numbers; this improves safety over the old way of carpooling where phone numbers were the primary means of contact.

### SUMMARY OF THE INVENTION

This invention provides a fast way for subscribers to find a ride through the use of Text Messaging or wireless email. First, several candidate passengers send a text message or email to the database requesting a ride and gives the start location (or street address) and desired direction of travel (see FIG. 6). Upon receiving these messages, the database looks up the Latitude and Longitude of each address and records each request. Secondly, a driver sends a text message indicating a willingness to drive and gives a start location (or street address) along with the direction of travel (see FIG. 7). The driver is immediately sent a reply giving the location of a nearby candidate passenger who shares the same direction of travel and that candidate passenger is removed from the list of candidates. By default, the driver is also given the cell phone number of the candidate passenger. (see FIG. 8)

Subscribers have the option to enroll into a privacy program where both parties are given a calling code instead of the driver calling the passenger directly. Both parties call a computer driven call center; they enter the membership number or temporary ID code of the other subscriber; once both parties have entered each other's code, they are connected together by 3-way calling. (see FIG. 9)

It is therefore an object of this invention to provide a system for matching potential ride sharing partners while making it possible to protect the privacy of the participants.

Another object of this invention is to provide a ride sharing program that finds matches automatically from just the Driver and Passenger entries without a third person dispatcher.

Other objects will become apparent from the following description of preferred embodiments of the invention.

While described above with reference primarily to methods, systems and computer program products for linking wireless texting technologies to a database for the purpose of matching a driver to a candidate passenger for a trip toward a common direction are also provided.

### BRIEF DESCRIPTION OF THE DRAWINGS

FIG. 1 is a schematic block diagram illustrating a Short Message Service system that links cell phones to the internet FIG. 2 is a schematic block diagram illustrating a driver and passenger matching system according to some embodiments of the present invention;

FIG. 3 is a block diagram of a data processing system utilizing a ride matching server illustrating some embodiments of the present invention;

FIG. 4 is a more detailed block diagram of a data processing system utilizing a ride matching server illustrating some embodiments of the present invention;

FIG. 5 is a flow chart illustrating sequence of operations for matching a driver with a candidate passenger for a trip toward a common direction according to some embodiments of the present invention;

FIG. 6 illustrates a typical text message from a Candidate Passenger requesting a ride, where the candidate provides:
1) A key word (here “ride”) that identifies the subscriber as a candidate passenger,
2) A desired direction of travel (n, nw, w, sw, s, se, e, ne),
3) Start location (such as a street address or Latitude-Longitude),
4) The city and state (or zip code) of the start location (omit #4 if Lat-Long in #3)
5) The cell phone's number or user's email address automatically identifies the user to the system.

FIG. 7 illustrates a typical text message from a Driver offering to drive, where the driver provides:
1) A key word (here “drive”) that identifies the subscriber as a driver.
2) A desired direction of travel (n, nw, w, sw, s, se, e, ne),
3) Start location (such as a street address or Latitude-Longitude),
4) The city and state (or zip code) of the start location (omit #4 if Lat-Long in #3)
5) The cell phone's number or user's email address automatically identifies the user to the system and does not need to be sent to the candidate passenger.

FIG. 8 illustrates a typical text message reply to a Driver showing the start location and phone number of the candidate passenger.

FIG. 9 illustrates a typical text message reply to a Driver where the candidate passenger has enrolled in the privacy program (explained in paragraph 0010).

FIG. 10 illustrates a typical text message reply to a Candidate Passenger where no Driver has been matched within a specific period of time.

While FIGS. 6 through 10 specifically illustrate the use of Text Messaging or SMS, a means of sending data to and from the database by other wireless text techniques are also provided such as by wireless email.

### DETAILED DESCRIPTION OF THE INVENTION

The present invention now will be described more fully herein with reference to the drawings, where in embodiments of the invention are shown. This invention may, however, be embodied in may different forms and should not be construed as limited to the embodiments set forth herein; instead, these embodiments are provided to disclose the functions of this invention completely and will fully describe the scope of the invention to those skilled in the art. The same numbers are carried from one figure to the next.

Those skilled in this art can see that the present invention can be delivered as a method, data processing system, and/or computer program product. Likewise, the present invention may be integrated entirely of hardware components or may utilize programmable hardware which relies on software programming such as Java, C++, html, or assembly language such that the instructions stored in processor-readable memory produce an article of manufacture including instruction means which perform the acts specified in the flowchart and/or block diagram blocks.

The computer program instructions may also be loaded onto a computer or other programmable data processing device to result in a series of operational steps to be performed on the device to produce a computer implemented process such that the instructions which execute on the device implement the acts specified in the flowchart and/or block diagram blocks

Embodiments of the present invention will now be described with reference to the figures. Embodiments of the present invention provide methods, systems and/or computer program products for matching a driver with a candidate passenger for a trip toward a common direction and provides a way of putting violators of the Terms of Service on an “Inactive” list, all without third party human intervention between users, while giving subscribers the option to preserve their privacy. Those capabilities allow the system to accommodate a onetime ride share arrangement.

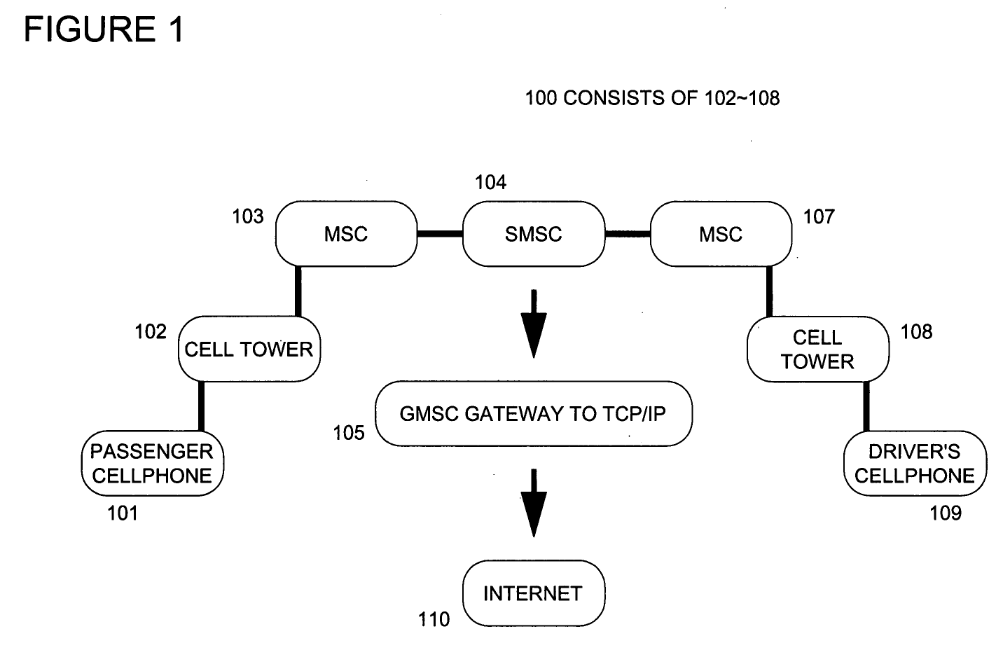

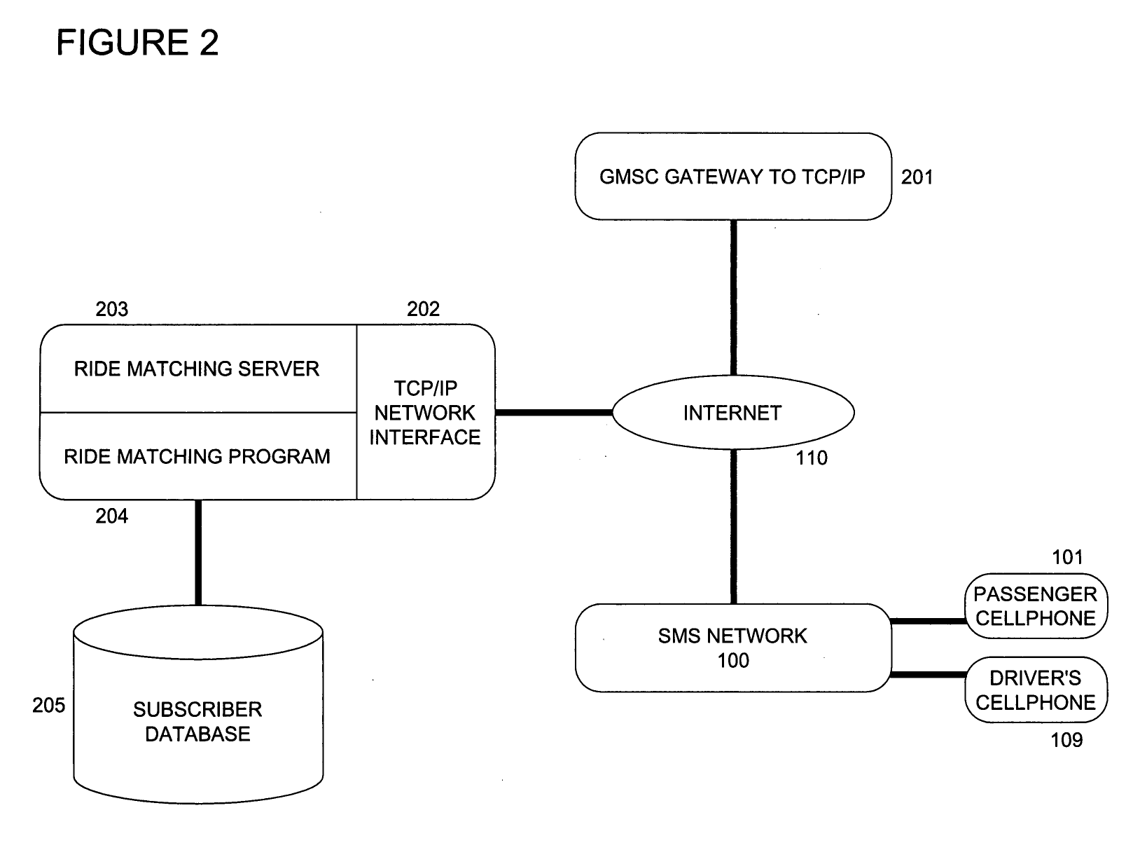

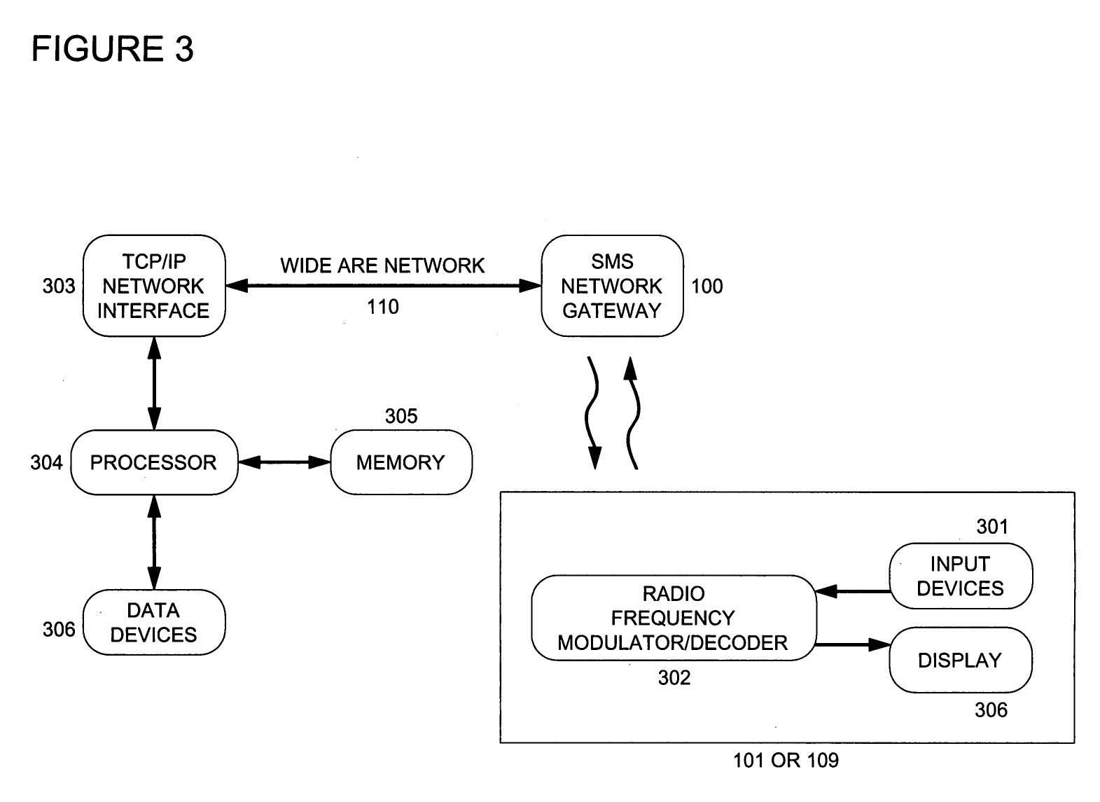

Referring to FIG. 3, the data input device 301 consists of the subscriber's cell phone keypad where a candidate passenger creates a request similar to one seen in FIG. 6. The subscriber sends the data by radio frequency modulation 302. The request is carried by radio wave to a cell tower 102 of FIG. 1 which relays the message to a Gateway 104. The 5 or 6 digit short code address provided by the sender determines the Internet URL where the request is sent over the Internet 110.

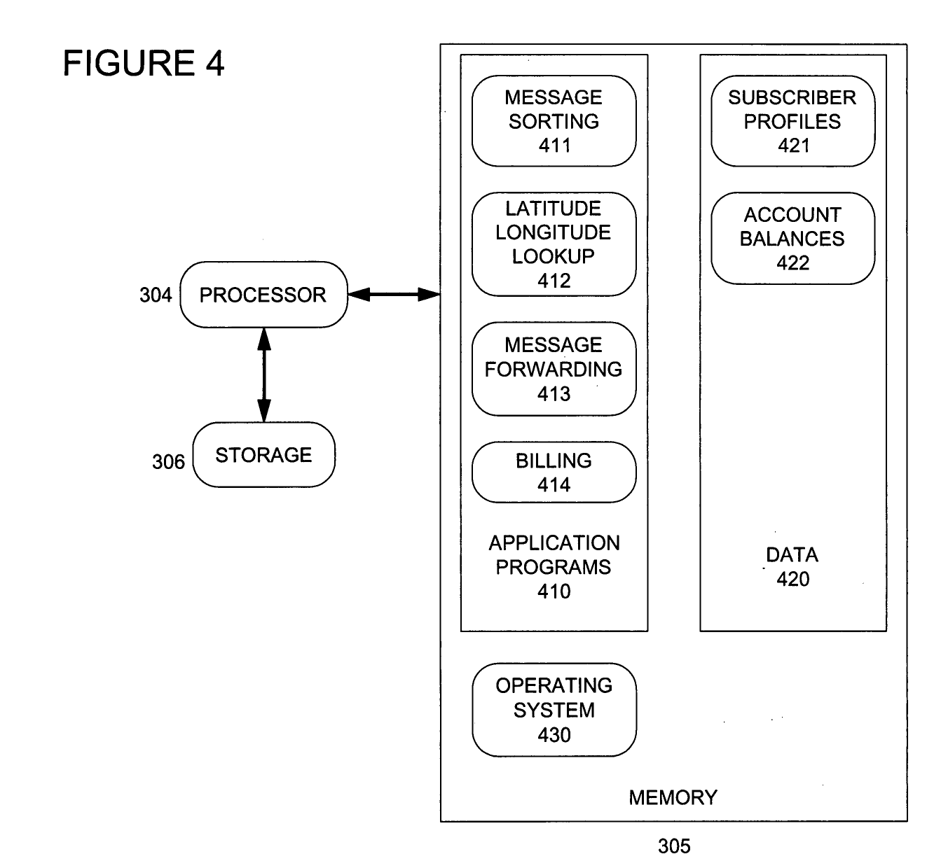

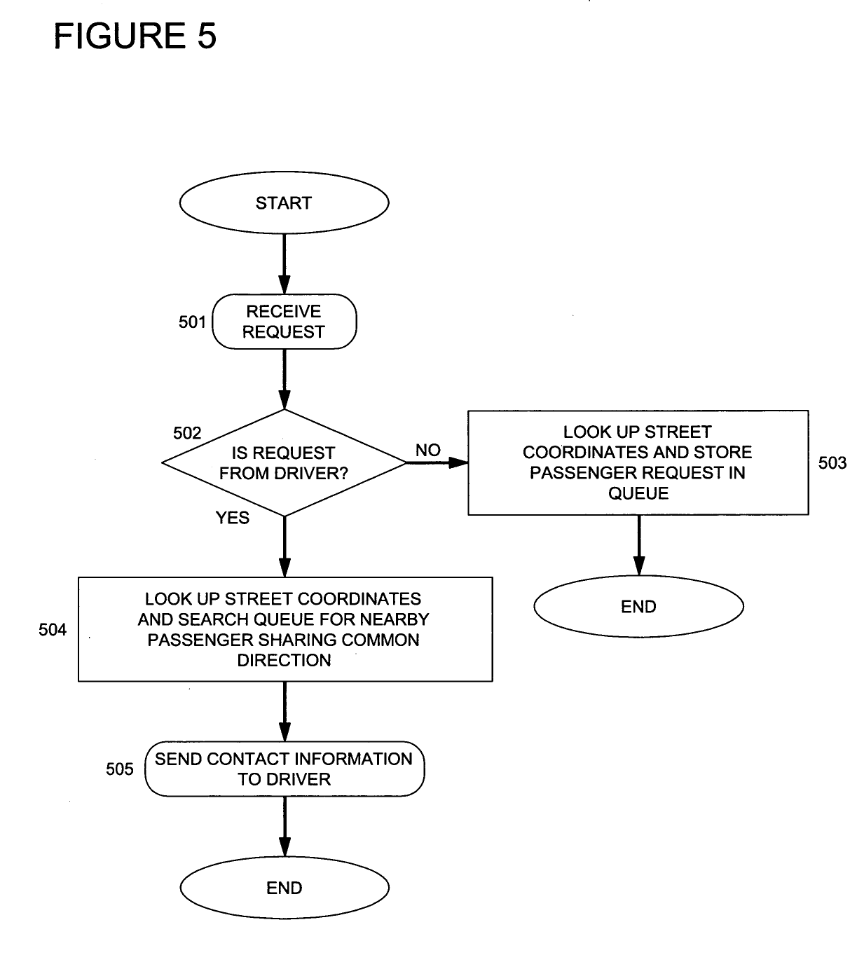

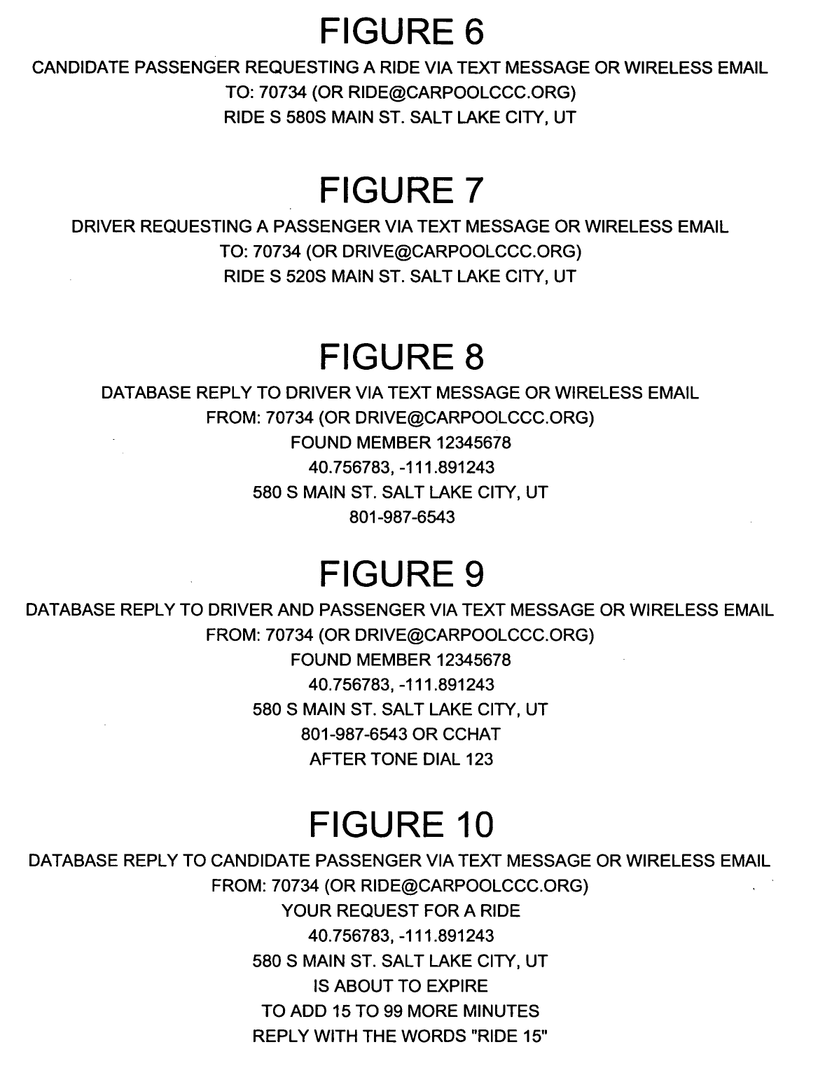

Once the request arrives at Network Interface 202 in FIG. 2, the Ride Matching Server 203 uses message sorting program 411 in FIG. 4 to verify membership status in the Subscriber Profiles 421 in FIG. 4 then perform the sorting function 502 in FIG. 5

The keyword “ride” in FIG. 6 triggers the command “NO” in block 502 of FIG. 5 resulting in lookup program 412 of FIG. 4 to perform step 503 in FIG. 5 where the request is stored in the queue.

Once steps 501, 502, 503 in FIG. 5 is performed by a plurality of candidate passengers, a driver inputs a request FIG. 7 on cell phone keypad 301 in FIG. 3 which in like manner is conveyed by gateway 100 to internet 110 and arrives at interface 303 then processor 304 uses sorting program 411 to verify membership in profile 421 and identify the keyword “drive” in FIG. 7 to trigger step 504 in FIG. 5 which uses lookup program 412 and searches the queue for a nearby candidate passenger who shares the same direction of travel request.

The candidate passenger selected by step 504 is removed from the queue and message of FIG. 8 is sent to the driver's display 306 in FIG. 3.

If the candidate passenger or driver has subscribed to privacy protection, step 505 of FIG. 5 will generate a contact number as illustrated in FIG. 9 where the driver and passenger both call a computer dispatched phone number, listens for a tone, then enters each other's contact number. Both calls are then connected together by 3-way calling so they can coordinate the exact pick up location. In this case, neither party is given the direct phone number to the other party.

Upon successful transmission of contact information, the Billing Application 414 of FIG. 4 will automatically debit the passenger's account and credit the driver's account balance 422 of FIG. 4

Message sorting application 411 also has the function of receiving subscriber complaints and recording these complaints into the subscriber profile 421 and automatically sending a warning message to the offending subscriber. When complaint status crosses a predetermined threshold, the offending subscriber is moved to “inactive” status where future matches will not be made.

As described above, it will be seen that ride matching systems according to various embodiments of the present invention may increase the usefulness of carpool scheduling by making such systems more flexible through automatic identification of candidate passengers based on the start location and desired travel direction. Such automated matching of candidate passengers may encourage the use of this system by forming a carpool in such a quick manner.

The flowcharts, and examples for FIG. 2 through 10 illustrate the architecture, functionality, and operation of possible implementations of systems, methods and computer program products for matching a driver with a candidate passenger for a trip from a start location toward a common direction according to embodiments of this present invention. In this manner, each function in the figures represents a module, segment, or portion of code, which comprises one or more executable instructions for performing particular logical acts. It should be noted that, in some alternative implementation, the acts noted in the figures may occur in different orders and still fulfill the purpose of this invention.

In the drawings and specifications, there have been disclosed typical illustrative embodiments of the invention and, although specific terms have been used to describe operations, they are offered in a generic intent only and not for purposes of limitation, the scope of the invention having been set forth in the claims of this patent.

We claim:

1. A method for matching a driver with a passenger to share rides toward a common direction, comprising: the establishment of a database linked to cell phones via Text Message Short Message Service (SMS) or by wireless email; linking to a database that has program code with the ability to look-up the latitude and longitude of street addresses; adding to the database information relating to a plurality of individual commuters, said information for each commuter including identifying tag, the origin and the desired direction of travel for each commuter; providing an analysis program that is integrated with said database to obtain for an inquiring driver, who furnishes to the database personal information including origin and desired direction of travel, a physical location, such as street address, of the origins and desired direction of travel of potential ride sharing partners.

2. The method of claim 1 wherein said identifying tag contains a cell phone number or email address identifying each user who sends a text message or wireless email to the database.

3. The method of claim 1 wherein said inquiring commuter is provided an SMS short-code or “mobile number” or email address by which they may send a text message or email to the database.

4. The method of claim 1 wherein the physical location (such as street address) is converted to Latitude and Longitude coordinates.

5. The method of claim 1 wherein said Latitude and Longitude origin coordinates and desired direction of travel of said candidate passenger is selected in relation to the origin coordinates and direction of the inquiring driver performed by an analysis program that is integrated with said database.

6. The method of claim 1 wherein said analysis program reports back to the driver the location and means of contacting a candidate passenger selected by the algorithm. This is done via Text message (SMS) or wireless email.

7. A method for maintaining the privacy of subscribers whereby each subscriber can be automatically sent a contact number of the ride partner. Subscribers will then be able to use this number to communicate with the other subscriber by text-message or cell-phone call.

8. The method of claim 7 for said text-message is a short code SMS number to which a subscriber can send a message to the database. The sender includes the contact number of the other subscriber. This number is used by the website to redirect the message to the other subscriber. The contact number may consist of the other subscriber's membership number or a temporary ID.

9. The method of claim 7 for said cell-phone call is the cell-phone number of the calling subscriber. The database verifies the membership of the caller by looking up the cell-phone caller ID number. The caller is then instructed to enter the membership number or temporary ID number of the other subscriber. After the caller enters a valid membership number or temporary ID number, the database sends a text message to invite the other subscriber to join an automated 3-way call.

10. A computer program product and data processing system to carry out the method of claim 1, that is, for matching a candidate passenger with a driver for a trip from an origin toward a common direction, the computer program product comprising: a computer-readable storage device having computer-readable program code stored in the device, said computer-readable program code comprising: computer-readable program code that identifies a candidate passenger for a trip based on a origin location for the candidate passenger responsive to a request from the driver; and computer-readable program code that keeps track of passenger and driver participation and makes appropriate charges to the passenger and compensation to the driver.

11. The computer program product of claim 10 takes the data received from a candidate passenger's request and looks up the latitude and longitudinal coordinates of the street address provided then identifies at least one of the plurality of candidate passengers based on the determined start location of the driver and the start location of the plurality of candidate passengers while using the desired direction of travel as a filter; and wherein the computer-readable program code establishes a communication connection between the candidate passenger and driver.
